(19) United States
(12) Patent Application Publication
(10) Pub. No.: US 2014/0017639 A1
(43) Pub. Date: Jan. 16, 2014

(54) AUTOMATION TRAINER FOR TRAINING TECHNICIAN, ENGINEERS AND TRADESMEN TO PROGRAM A PROGRAMMABLE AUTOMATION CONTROLLER

(71) Applicant: Mark Siedlik, Canton, MI (US)

(72) Inventor: Mark Siedlik, Canton, MI (US)

(21) Appl. No.: 13/858,918

(22) Filed: Apr. 8, 2013

Related U.S. Application Data
(60) Provisional application No. 61/621,351, filed on Apr. 6, 2012.

(51) Int. Cl. G09B 19/00

(52) U.S. Cl. CPC G09B 19/0053
USPC 434/118

(57) ABSTRACT

An automation trainer is useful for students to develop programs then download to a programmable automation controller (PAC) or a programmable logic controller (PLC). The programs can be used to sequence cylinders that are controlled by valves and sensors. The automation trainer, along with lab experiments, simulate real world problem solving and programming. The automation trainer simulates real world machines and is easily expandable and flexible.

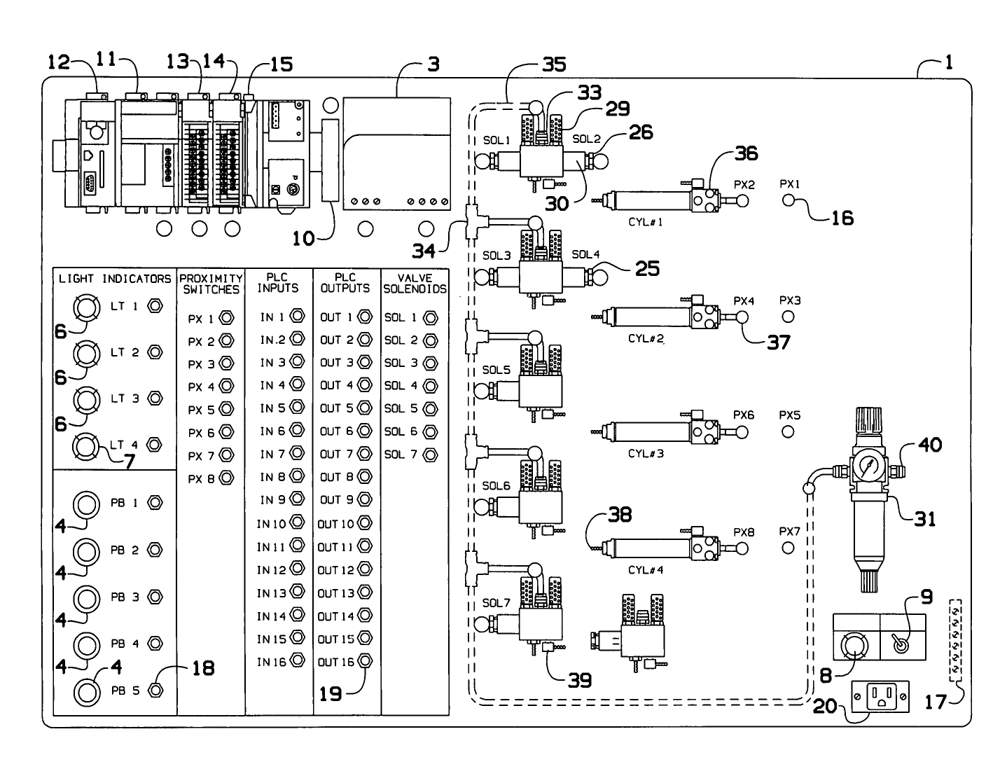

### CROSS-REFERENCE TO RELATED APPLICATION

This application claims the benefit of priority of U.S. provisional application No. 61/621,351, filed Apr. 6, 2012, the contents of which are herein incorporated by reference.

### BACKGROUND OF THE INVENTION

The present invention relates to automation trainers and, more particularly, to an automation trainer used to train technicians, engineers and tradesmen to program a programmable automation controller (PAC) or a programmable logic controller (PLC). The programs can be used to sequence cylinders that are controlled with directional control valves and proximity sensors.

Conventional trainers typically do not involve moving equipment. Instead, they simply have push buttons and switches for inputs and lights for output devices. These conventional trainers often require the students to imagine the light (output) is a machine, without ever seeing any motion.

Also, many of the current trainers tend to be limited in their expand ability and use a curriculum that is poorly written from a problem solving standpoint and, instead, focuses on a rote learning background.

As can be seen, there is a need for an automation trainer that helps teach students how to wire, setup and program a PAC or PLC along with a curriculum that involves problem solving for lab experiments that become progressively harder and involve motion control of a simulated machine.

### SUMMARY OF THE INVENTION

In one aspect of the present invention, an automation trainer comprises a processor; an input module for providing a program to the processor; a power supply for converting alternating current to direct current; a plurality of indicator lights; a plurality of proximity switches; a plurality of input jacks; a plurality of output jacks; a plurality of solenoid valves; a plurality of cylinders, wherein extending the cylinders activates an associated proximity sensor; and a pneumatic filter/regulator supplying a pneumatic source to the solenoid valves, wherein a student can interconnect the indicator lights, the proximity switches, the input jacks, the output jacks, the solenoid valves and the cylinders to create a machine cycle operating according to the program in the processor.

These and other features, aspects and advantages of the present invention will become better understood with reference to the following drawing, description and claims.

### BRIEF DESCRIPTION OF THE DRAWING

The FIGURE is a schematic representation of an automation controller according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an automation trainer that is useful for students to develop programs then download to a programmable automation controller (PAC) or a programmable logic controller (PLC). The programs can be used to sequence cylinders that are controlled by valves and sensors. The automation trainer, along with lab experiments, simulate real world problem solving and programming. The automation trainer simulates real world machines and is easily expandable and flexible.

Referring now to the FIGURE, students can create a program on a computer and can download the program to a PLC processor 12, such as a Compactlogix processor or a Siemens processor, for example. The student can use patch cords to wire up the push button inputs 4 and the input proximity sensors PX1 through PX8, for example, to the input addresses off the input module 13, such as a Compactlogix or Siemens input module. The inputs 18 can be designated by, for example, black banana jacks, while the outputs 19 can be designated by, for example, red banana jacks. Light indicators 6, 7 can provide lights as desired by the programming.

The student can then wire up the output solenoids SOL1 through SOL7, for example, off of the valves to the output jacks OUT1 through OUT 16, for example. Pushing the buttons can cause the output solenoids on the valves 25, 26 to energize, shifting the pneumatic valves and causing the cylinders 36 to extend and retract. A DIN plug assembly with lights 30 can be disposed on the solenoid valves 25, 26. Barbed fittings 38, 39 can be used to interconnect the solenoids with the cylinders 36. The valves 25, 26 can be double solenoid detent valves that are two-position, four-way, 5-ported/8 exhaust speed control with 5⅛ inch NPT sub-base for the valves. The cylinders 36 can be double acting, single rod, four inch cylinders with block mounting, for example.

The solenoid valves can include a pneumatic fitting 33 for interconnecting tubing 35 that can extend from a filter/regulator 31. Tee fittings 34 can be used to connect the tubing 35 to multiple solenoid valves. The filter/regulator 31 can connect to a pneumatic supply through a main quick connect fitting 40.

Proximity sensors 16 can detect whether the cylinders 36 are extended (where a nut 37, or the like, on the end of the cylinder 36 can be detected by the proximity sensors 16) or retracted according to the machine cycle in the lab experiment. The proximity sensors 16 can be 24V-DC, 3-wire, 12 mm outside diameter proximity sensors with a 3 mm range, for example.

A toggle switch 9 can be provided to power the automation trainer. A power-on light 8, such as a red LED can indicate when the power is on at the switch 9.

A power supply 3, such as an Allen-Bradley power supply, can convert 120V-AC to 24V-DC. A 120V-AC, 2 pole with ground receptacle 20 can be provided on the automation trainer. A ground bar 17 can be provided at one or more locations on the automation trainer. A circuit protection device 10 can be provided to provide circuit protection for the 120V-AC power.

A power supply 11, such as a Compactlogix or a Siemens power supply, can provide power to the processor 12. An output module 14, such as an Allen-Bradley Compactlogix or a Siemens output module can be provided. A right end cap 15 can be disposed on the output module 14. In some embodiments, an optional devicenet module and an optional Ethernet switch can be provided, depending on the communication asked for by the customer. A touch screen panel (Human Machine Interface) could also be added to the automation trainer.

Students can write programs that will produce a simulated machine cycle. They can then wire up the input devices, such as the proximity sensors and push buttons, to the input addresses and the output devices, such as the lights and solenoids on the valves, to the output addresses. When the student push the start button, and if the program is correct, the automation trainer 1 will sequence the cylinders to behave like a simulated machine cycle. The program can be written in ladder logic, structured text, or function blocks, to control a machine cycle.

The components of the automation trainer can be mounted on a anodized aluminum subplate, which can be mounted in a large carrying case. If more than one trainer is ordered, the customer will have the option of mounting the subplate to a panel, which can then be mounted on a large industrial cart, with storage drawers for patch cords, communication cables and laptops. The automation trainer can be built in a modular manner so that the power components, such as the valves and the cylinders (the components on the right-hand side of the FIGURE), could be used with either a Siemens PLC or an Allen-Bradley PLC.

To use the automation trainer, in some embodiments, students can be given a lab experiment manual with progressively harder lab experiments. The students can then use the software on the laptops to write programs for the lap experiments. The lab experiments can be written in a problem solving format. The students can wire up their input devices, their output devices and, by pushing the start button, can start the process of the simulated machine cycle.

It should be understood, of course, that the foregoing relates to exemplary embodiments of the invention and that modifications may be made without departing from the spirit and scope of the invention as set forth in the following claims.

What is claimed is:

1. An automation trainer comprising:
a processor;
an input module for providing a program to the processor;
a power supply for converting alternating current to direct current;
a plurality of indicator lights;
a plurality of proximity switches;
a plurality of input jacks;
a plurality of output jacks;
a plurality of solenoid valves;
a plurality of cylinders, wherein extending the cylinders activates an associated proximity sensor; and
a pneumatic filter/regulator supplying a pneumatic source to the solenoid valves, wherein
a student can interconnect the indicator lights, the proximity switches, the input jacks, the output jacks, the solenoid valves and the cylinders to create a machine cycle operating according to the program in the processor.

2. The automation trainer of claim 1, further comprising a power-on toggle switch.

3. The automation trainer of claim 1, further comprising a power-on indicator light illuminating when the power-on toggle switch is turned on.

4. The automation trainer of claim 1, further comprising an output module for outputting information from the processor.

5. The automation trainer of claim 1, wherein the plurality of input jacks are black banana jacks.

6. The automation trainer of claim 1, wherein the plurality of output jacks are red banana jacks.

7. The automation trainer of claim 1, further comprising a ground bar.
